(19) United States
(12) Patent Application Publication
(10) Pub. No.: US 2026/0048620 A1
(43) Pub. Date: Feb. 19, 2026

(54) Motor Vehicle Tire Pressure Maintainer Device

(71) Applicant: N Hanz Scholz, Winthrop, WA (US)

(72) Inventor: N Hanz Scholz, Winthrop, WA (US)

(21) Appl. No.: 19/083,532

(22) Filed: Mar. 19, 2025

Related U.S. Application Data
(60) Provisional application No. 63/682,380, filed on Aug. 13, 2024.

(51) Int. Cl. B60C 23/04; B60B 21/02; G07C 5/00

(52) U.S. Cl. CPC B60C 23/0493; B60B 21/025; B60C 23/0479; G07C 5/008

(57) ABSTRACT

A tire pressure maintainer device is disclosed, which is a modified tire rim designed to act as a high-pressure reservoir. The tire pressure maintainer device comprises a tire rim with hollowed out sections, an inlet to the hollowed-out sections, and a regulator connecting the high-pressure section of the rim to the inside of the tire. The inlet on the rim will be used to highly pressurize the tire rim, much higher than the optimal pressure for the tire. Then, as the tire itself loses pressure over time, the regulator between the rim and the tire will slowly release pressure to ensure that the tire maintains its optimal pressure range. This feature will ensure vehicle owners need to stop less frequently to add air into their tires but will also provide better fuel economy and safer environment for the driver by preventing excessive tire wear and accidents.

### CROSS-REFERENCE TO RELATED APPLICATION

The present application claims priority to, and the benefit of, U.S. Provisional Application No. 63/682,380, which was filed on Aug. 13, 2024, and is incorporated herein by reference in its entirety.

### FIELD OF THE INVENTION

The present invention relates generally to the field of tire pressure maintainer devices. More specifically, the present invention relates to a tire pressure management system built directly into the tire rim. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in tire pressure maintainer devices. Generally, vehicle tires inevitably lose air over time and must be refilled to keep the vehicle operating in peak condition. Further, some vehicle owners may not pay enough attention to their tire pressure (PSI) and drive around with low air pressure in their tires. However, serious accidents can occur due to tires with low air pressure.

Additionally, fuel and tires represent the greatest operating cost for a single tractor/trailer or an entire fleet. If a truck tire that normally operates at 100 psi is 25-30% under inflated, this causes excessive thread-wear due to heat and friction and reduces fuel efficiency due to resistance and drag. Under-inflation also negatively impacts the longevity of tire casings. Furthermore, tires at low pressure wear out more easily and consume more fuel.

Accordingly, there is a demand for an improved tire pressure maintainer device that provides users with a tire pressure management system that is built directly into the tire rim. More particularly, there is a demand for a tire pressure maintainer device that eliminates the need to stop and refill tires with air while offering better fuel economy and safer driving environments.

Therefore, there exists a long felt need in the art for a tire pressure maintainer device that provides users with a tire pressure management system built directly into the tire rim. There is also a long felt need in the art for a tire pressure maintainer device that keeps a vehicle's tires at the manufacturer specified pressure through a hollowed out section within the rim and a regulator that connects the high pressure section of the rim and the tire interior. Further, there is a long felt need in the art for a tire pressure maintainer device that utilizes a regulator between the rim and tire to slowly release air into the tire and maintain optimal tire pressure. Moreover, there is a long felt need in the art for a device that features a paired smartphone app that notifies vehicle owners of their tire pressure (PSI) through a Bluetooth connection. Further, there is a long felt need in the art for a tire pressure maintainer device that eliminates the need to stop and refill tires with air while offering better fuel economy and safer driving environments. Finally, there is a long felt need in the art for a tire pressure maintainer device that can be a retrofit on a standard car rim.

The subject matter disclosed and claimed herein, in one embodiment thereof, comprises a tire pressure maintainer device. The device is a modified tire rim designed to act as a high pressure reservoir. The tire pressure maintainer device comprises a tire rim with hollowed out sections, an inlet to the hollowed-out sections, and a regulator connecting the high pressure section of the rim to the inside of the tire. The inlet on the rim will be used to highly pressurize the tire rim, much higher than the optimal pressure for the tire. Then, as the tire itself loses pressure over time, the regulator between the rim and the tire will slowly release pressure to ensure that the tire maintains its optimal pressure range. This feature will ensure vehicle owners need to stop less frequently to add air into their tires but will also provide better fuel economy and safer environment for the driver by preventing excessive tire wear and accidents. Further, notifications can be sent through the Bluetooth paired smartphone app that shows the PSI of each tire.

In this manner, the tire pressure maintainer device of the present invention accomplishes all of the forgoing objectives and provides users with a device that is built directly into the tire rim to manage tire pressure. The device is a modified tire rim designed to act as a high-pressure reservoir. The device can be retrofitted on a standard car rim.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a tire pressure maintainer device. The device is a modified tire rim designed to act as a high pressure reservoir. The tire pressure maintainer device comprises a tire rim with hollowed out sections, an inlet to the hollowed-out sections, and a regulator connecting the high-pressure section of the rim to the inside of the tire. As the tire itself loses pressure over time, the regulator between the rim and the tire will slowly release pressure to ensure that the tire maintains its optimal pressure range. This feature will ensure vehicle owners need to stop less frequently to add air into their tires and creates a safer environment for the driver by preventing excessive tire wear and accidents.

In one embodiment, the tire pressure maintainer device is built directly into the tire rim of a vehicle tire. Any suitable vehicle tire can be utilized with the device as is known in the art. Further, the device would need to be applied to each vehicle tire of a suitable vehicle to maintain the manufacturer-specified pressure of the vehicle's tires. Thus, the tire pressure maintainer device eliminates the need to stop and refill tires with air while offering better fuel economy and safer driving environments.

In one embodiment, the tire pressure maintainer device is a modified tire rim designed to act as a high-pressure reservoir. Specifically, the tire pressure maintainer device comprises a tire rim with hollowed-out sections. Any suitable number of hollowed-out sections can be utilized within the modified tire rim as is known in the art. The hollowed-out sections would be interconnected to form one large reservoir for retaining air for the vehicle tire. The hollowed-out sections can be any suitable shape and size as is known in the art, depending on the shape and size of the tire rim.

In one embodiment, the tire pressure maintainer device comprises an inlet that provides access to the hollowed-out sections. The inlet can be any suitable inlet as is known in the art, as long as air can enter the inlet to fill the hollowed-out sections. The inlet can be any suitable valve as is known in the art. Typically, the inlet is a one-way valve that only allows air to enter the hollowed-out reservoirs and not to come back out through the inlet. The inlet can be positioned on any suitable position on the tire rim. The inlet on the tire rim is used to highly pressurize the tire rim and fill the hollowed-out reservoirs with air. Typically, the tire rim is pressurized much higher than the optimal pressure required for the tire.

In one embodiment, the tire pressure maintainer device includes a regulator that connects the high-pressure section of the rim to the inside of the tire. The regulator can be any suitable regulator as is known in the art. Typically, the regulator comprises a tensioned spring that is tensioned based on the pressure of the interior of the tire, such that the regulator automatically opens when the pressure within the tire drops to a certain level releasing air into the tire from the hollowed-out reservoirs. Thus, as the tire loses pressure over time, the regulator between the rim and the tire will slowly release air into the tire to maintain the tire's optimal pressure range. This feature will ensure vehicle owners need to stop less frequently to add air into their tires but will also provide better fuel economy and safer environment for the driver by preventing excessive tire wear and accidents.

In one embodiment, the tire pressure maintainer device can be paired with a smart device for notifications and alerts. Specifically, the smart device can be a mobile device or a cellular telephone, a remote control, or any other device that may have wireless communication capabilities and may be connected to the internet. The smart device may perform any type of wireless communication, including, but not limited to, WIFI, BLUETOOTH, RFID, NFC, etc. The tire pressure maintainer device further includes a wireless communication module and additional sensors which would allow the device to pair with a mobile application on the smart device. Once paired, a user could control the tire pressure maintainer device via the mobile application. Specifically, notifications can be sent through the Bluetooth paired mobile application to alert a user of a low-pressure warning. Users can also remotely add air to the vehicle tires via the regulator by using the mobile application. Further, the mobile application can display the pressure (i.e., PSI) of each tire, allowing a user to monitor and maintain the tire pressures with case.

In one embodiment, the smart device can be paired directly with the vehicle bus of the vehicle. The vehicle bus further includes a wireless communication module and additional sensors which would allow the vehicle bus to pair with a mobile application on the smart device. Typically, most vehicles comprise at least one sensor on or near a vehicle's tires to alert a user/driver of the vehicle of each tire's pressure. The at least one sensors are in communication with the vehicle and specifically, the vehicle bus. Thus, in this embodiment, the vehicle bus can pair with the mobile application on the smart device. Once paired, a user could control the tire pressure maintainer device via the mobile application. Specifically, notifications of low pressure sensed by the at least one sensor can be sent through the mobile application to alert a user of a low-pressure warning. For example, the mobile application can send audible and/or textual alerts via the smart phone that can notify a driver that a specific tire or tires have low pressure. Further, the mobile application can display the pressure (i.e., PSI) of each tire, allowing a user to monitor and maintain the tire pressures with ease.

In one embodiment, the device would comprise a means for allowing the regulator to fully vent the hollowed-out reservoirs during a blow out, to allow a driver to keep control of the vehicle and not wreck. In this embodiment, the device would comprise a second valve to vent the pressure from the tire rim when a blowout occurs. Further, the at least one sensors can be utilized to sense the blow out and alert the vehicle bus. The vehicle bus can then activate the second valve to vent all the air from the tire rim reservoirs, as needed.

In one embodiment, the tire pressure maintainer device is incorporated into the vehicle at the point of manufacture. In another embodiment, the tire pressure maintainer device can be retrofitted on a standard vehicle tire rim by attaching a pressure vessel that secures to the tire rim in different ways. A tube attached to the current valve is then attached with a pressure regulator to supply air to the tire. The pressure vessel could use the bolts on the tire and be made to accommodate rim size. It could also be attached via lead weights, which are used to balance the tire by crimping the pressure vessel to the edge of the rim. The tire rim can also be drilled and tapped so the device can be bolted to the rim, etc.

In yet another embodiment, the tire pressure maintainer device comprises a plurality of indicia.

In yet another embodiment, a method of maintaining tire pressure within a vehicle tire is disclosed. The method includes the steps of providing a tire pressure maintainer device comprising a modified tire rim with hollowed out sections, an inlet, and a regulator. The method also comprises utilizing the inlet to highly pressurize the tire rim. Further, the method comprises as the tire loses pressure over time, utilizing the regulator between the rim and the tire to slowly release pressure to ensure that the tire maintains optimal pressure. The method also comprises sending notifications through a Bluetooth paired smartphone app. Finally, the method comprises viewing the PSI of each tire on the paired smartphone app.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the tire pressure maintainer device of the present invention showing a cross-sectional view of the tire, the tire rim, and the pressure reservoir in accordance with the disclosed architecture;

FIG. 2 illustrates a perspective view of one embodiment of the tire pressure maintainer device of the present invention showing air pressure being released into the tire in accordance with the disclosed architecture;

FIG. 3 illustrates a perspective view of one embodiment of the tire pressure maintainer device of the present invention showing the tire pressure being adjusted from the rim in accordance with the disclosed architecture;

FIG. 4 illustrates a perspective view of one embodiment of the tire pressure maintainer device of the present invention showing the device communicating with a smart phone app through Bluetooth in accordance with the disclosed architecture;

FIG. 5 illustrates a perspective view of one embodiment of the tire pressure maintainer device of the present invention showing the tire pressure viewed on the smart phone app in accordance with the disclosed architecture; and

FIG. 6 illustrates a flowchart showing the method of maintaining tire pressure within a vehicle tire in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a tire pressure maintainer device that provides users with a tire pressure management system built directly into the tire rim. There is also a long felt need in the art for a tire pressure maintainer device that keeps a vehicle's tires at the manufacturer specified pressure through a hollowed out section within the rim and a regulator that connects the high pressure section of the rim and the tire interior. Further, there is a long felt need in the art for a tire pressure maintainer device that utilizes a regulator between the rim and tire to slowly release air into the tire and maintain optimal tire pressure. Moreover, there is a long felt need in the art for a device that features a paired smartphone app that notifies vehicle owners of their tire pressure (PSI) through a Bluetooth connection. Further, there is a long felt need in the art for a tire pressure maintainer device that eliminates the need to stop and refill tires with air while offering better fuel economy and safer driving environments. Finally, there is a long felt need in the art for a tire pressure maintainer device that can be a retrofit on a standard car rim.

The present invention, in one exemplary embodiment, is a novel tire pressure maintainer device. The device is a modified tire rim designed to act as a high-pressure reservoir. The tire pressure maintainer device comprises a tire rim with hollowed out sections, an inlet to the hollowed-out sections, and a regulator connecting the high-pressure section of the rim to the inside of the tire. The inlet on the rim will be used to highly pressurize the tire rim, much higher than the optimal pressure for the tire. Then, as the tire itself loses pressure over time, the regulator between the rim and the tire will slowly release pressure to ensure that the tire maintains its optimal pressure range. Further, notifications can be sent through the Bluetooth paired smartphone app that shows the PSI of each tire. The present invention also includes a novel method of maintaining tire pressure within a vehicle tire. The method includes the steps of providing a tire pressure maintainer device comprising a modified tire rim with hollowed out sections, an inlet, and a regulator. The method also comprises utilizing the inlet to highly pressurize the tire rim. Further, the method comprises as the tire loses pressure over time, utilizing the regulator between the rim and the tire to slowly release pressure to ensure that the tire maintains optimal pressure. The method also comprises sending notifications through a Bluetooth paired smartphone app. Finally, the method comprises viewing the PSI of each tire on the paired smartphone app.

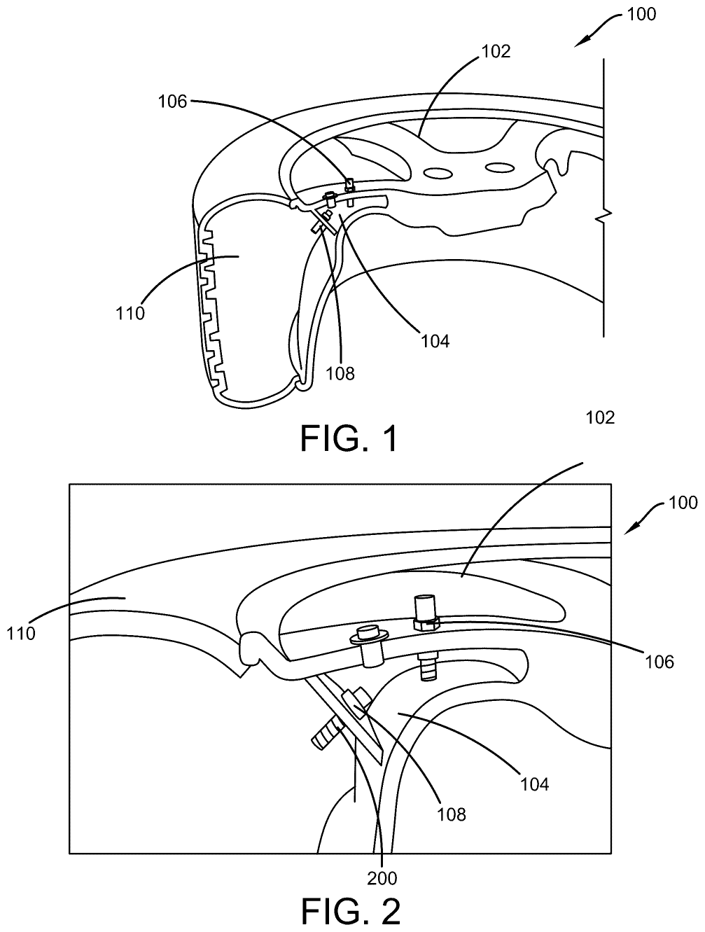

Referring initially to the drawings, FIG. 1 illustrates a perspective view of one embodiment of the tire pressure maintainer device 100 of the present invention. In the present embodiment, the tire pressure maintainer device 100 is an improved tire pressure maintainer device 100 that provides a user 112 with a modified tire rim which acts as a high-pressure reservoir. Specifically, the tire pressure maintainer device 100 comprises a tire rim 102 with hollowed-out sections 104, an inlet 106 to the hollowed-out sections 104, and a regulator 108 connecting the hollowed-out sections 104 of the rim 102 to the inside of the tire 110. As the tire 110 itself loses pressure over time, the regulator 108 between the rim 102 and the tire 110 will slowly release pressure to ensure that the tire 110 maintains its optimal pressure range. This feature will ensure vehicle owners (i.e., users 112) need to stop less frequently to add air into their tires 110 and creates a safer environment for the driver (i.e., user 112) by preventing excessive tire wear and accidents.

Generally, the tire pressure maintainer device 100 is built directly into the tire rim 102 of a vehicle tire 110. Any suitable vehicle tire 110 can be utilized with the device 100 as is known in the art. Further, the device 100 would need to be applied to each vehicle tire 110 of a suitable vehicle 114 to maintain the manufacturer-specified pressure of the vehicle's tires 110. Thus, the tire pressure maintainer device 100 eliminates the need to stop and refill tires 110 with air while offering better fuel economy and safer driving environments.

As shown in FIG. 2, the tire pressure maintainer device 100 is a modified tire rim designed to act as a high-pressure reservoir. Specifically, the tire pressure maintainer device 100 comprises a tire rim 102 with hollowed-out sections 104. Any suitable number of hollowed-out sections 104 can be utilized within the modified tire rim 102 as is known in the art. The hollowed-out sections 104 would be interconnected to form one large reservoir for retaining air for the vehicle tire 110. The hollowed-out sections 104 can be any suitable shape and size as is known in the art, depending on the shape and size of the tire rim 102.

Further, the tire pressure maintainer device 100 includes a regulator 108 that connects the high-pressure section (i.e., hollowed-out sections 104) of the rim 102 to the inside of the tire 110. The regulator 108 can be any suitable regulator as is known in the art. Typically, the regulator 108 comprises a tensioned spring 200 that is tensioned based on the pressure of the interior of the tire 110, such that the regulator 108 automatically opens when the pressure within the tire 110 drops to a certain level releasing air into the tire 110 from the hollowed-out reservoirs 104. Thus, as the tire 110 loses pressure over time, the regulator 108 between the rim 102 and the tire 110 will slowly release air into the tire 110 to maintain the tire's optimal pressure range. This feature will ensure vehicle owners (i.e., users 112) need to stop less frequently to add air into their tires 110 but will also provide better fuel economy and safer environment for the driver 112 by preventing excessive tire 110 wear and accidents.

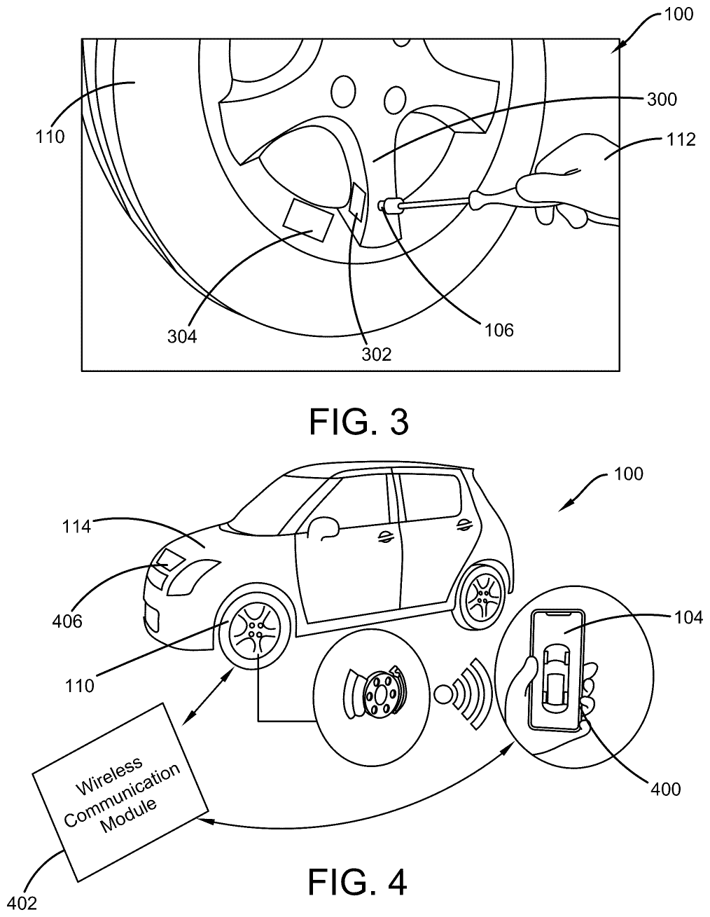

As shown in FIG. 3, the tire pressure maintainer device 100 comprises an inlet 106 that provides access to the hollowed-out sections 104. The inlet 106 can be any suitable inlet as is known in the art, as long as air can enter the inlet 106 to fill the hollowed-out sections 104. The inlet 106 can be any suitable valve as is known in the art. Typically, the inlet 106 is a one-way valve that only allows air to enter the hollowed-out reservoirs 104 and not to come back out through the inlet 106. The inlet 106 can be positioned on any suitable position on the tire rim 102. The inlet 106 on the tire rim 102 is used to highly pressurize the tire rim 102 and fill the hollowed-out reservoirs 104 with air. Typically, the tire rim 102 is pressurized much higher than the optimal pressure required for the tire 110.

Further, in one embodiment, the device 100 would comprise a means for allowing the regulator 108 to fully vent the hollowed-out reservoirs 104 during a blow out, to allow a driver (i.e., user 112) to keep control of the vehicle 114 and not wreck. In this embodiment, the device 100 would comprise a second valve 300 to vent the pressure from the tire rim 102 when a blowout occurs. Further, a conventional vehicle 114 typically comprises at least one sensor 302 which senses a vehicle's tire pressure. This at least one sensor 302 can be utilized to sense a blow-out and alert the vehicle bus 406. The vehicle bus 406 can then activate the second valve 300 to vent all the air from the tire rim reservoirs 104, as needed.

In one embodiment, the tire pressure maintainer device 100 is incorporated into the vehicle 114 at the point of manufacture. In another embodiment, the tire pressure maintainer device 100 can be retrofitted on a standard vehicle tire rim 102 by attaching a pressure vessel 304 that secures to the tire rim 102 in different ways. A tube (not shown) attached to the current valve is then attached with a pressure regulator to supply air to the tire 110. The pressure vessel 304 could use the bolts on the tire 110 and be made to accommodate rim size. It could also be attached via lead weights, which are used to balance the tire 110 by crimping the pressure vessel 304 to the edge of the rim 102. The tire rim 102 can also be drilled and tapped so the device 100 can be bolted to the rim 102, etc.

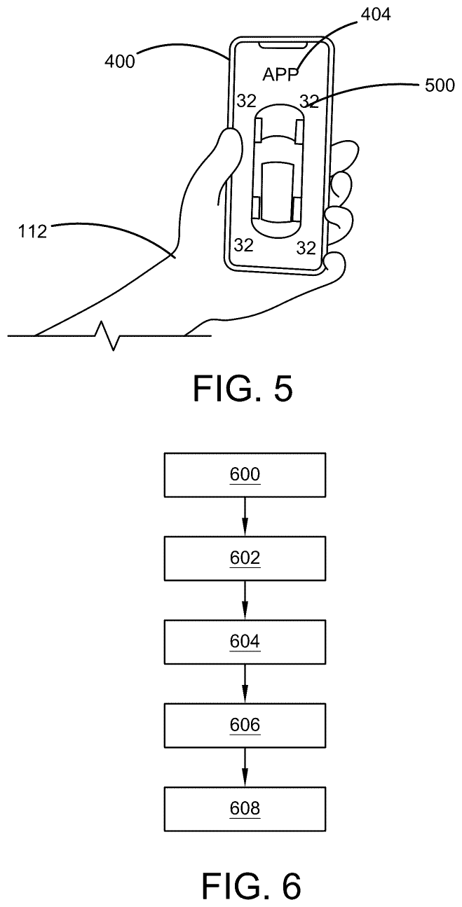

As shown in FIGS. 4-5, in one embodiment, the tire pressure maintainer device 100 can be paired with a smart device 400 for notifications and alerts. Specifically, the smart device 400 can be a mobile device or a cellular telephone, a remote control, or any other device that may have wireless communication capabilities and may be connected to the internet. The smart device 400 may perform any type of wireless communication, including, but not limited to, WIFI, BLUETOOTH, RFID, NFC, etc. The tire pressure maintainer device 100 further includes a wireless communication module 402 and additional sensors which would allow the device 100 to pair with a mobile application 404 on the smart device 400. Once paired, a user 112 could control the tire pressure maintainer device 100 via the mobile application 404. Specifically, notifications can be sent through the Bluetooth paired mobile application 404 to alert a user 112 of a low-pressure warning. Users 112 can also remotely add air to the vehicle tires 110 via the regulator 108 by using the mobile application 404. Further, the mobile application 404 can display the pressure (i.e., PSI) of each tire 110, allowing a user 112 to monitor and maintain the tire pressures with case.

In another embodiment, the smart device 400 can be paired directly with the vehicle bus 406 of the vehicle 114. The vehicle bus 406 further includes a wireless communication module 402 and additional sensors which would allow the vehicle bus 406 to pair with a mobile application 404 on the smart device 400. Typically, most vehicles 114 comprise at least one sensor 302 on or near a vehicle's tires 110 to alert a user/driver 112 of the vehicle 114 of each tire's pressure. The at least one sensors 302 are in communication with the vehicle 114 and specifically, the vehicle bus 406. Thus, in this embodiment, the vehicle bus 406 can pair with the mobile application 404 on the smart device 400. Once paired, a user 112 could control the tire pressure maintainer device 100 via the mobile application 404. Specifically, notifications of low pressure sensed by the at least one sensor 302 can be sent through the mobile application 404 to alert a user 112 of a low-pressure warning. For example, the mobile application 404 can send audible and/or textual alerts via the smart phone 400 that can notify a driver 112 that a specific tire or tires 110 have low pressure. Further, the mobile application 404 can display the pressure (i.e., PSI) of each tire 110, allowing a user 112 to monitor and maintain the tire pressures with case.

In yet another embodiment, the tire pressure maintainer device 100 comprises a plurality of indicia 500. The mobile application 404 of the device 100 may include advertising, a trademark, or other letters, designs, or characters, printed, painted, stamped, or integrated into the mobile application 404, or any other indicia 500 as is known in the art. Specifically, any suitable indicia 500 as is known in the art can be included, such as but not limited to, patterns, logos, emblems, images, symbols, designs, letters, words, characters, animals, advertisements, brands, etc., that may or may not be tire pressure, tire rim, or brand related.

FIG. 6 illustrates a flowchart of the method of maintaining tire pressure within a vehicle tire. The method includes the steps of at 600, providing a tire pressure maintainer device comprising a modified tire rim with hollowed out sections, an inlet, and a regulator. The method also comprises at 602, utilizing the inlet to highly pressurize the tire rim. Further, the method comprises at 604, as the tire loses pressure over time, utilizing the regulator between the rim and the tire to slowly release pressure to ensure that the tire maintains optimal pressure. The method also comprises at 606, sending notifications through a Bluetooth paired smartphone app. Finally, the method comprises at 608, viewing the PSI of each tire on the paired smartphone application.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “tire pressure maintainer device”, “tire pressure device”, “pressure maintainer device”, and “device” are interchangeable and refer to the tire pressure maintainer device 100 of the present invention.

Notwithstanding the forgoing, the tire pressure maintainer device 100 of the present invention can be of any suitable size and configuration as is known in the art without affecting the overall concept of the invention, provided that it accomplishes the above stated objectives. One of ordinary skill in the art will appreciate that the tire pressure maintainer device 100 as shown in FIGS. 1-6 is for illustrative purposes only, and that many other sizes and shapes of the tire pressure maintainer device 100 are well within the scope of the present disclosure. Although the dimensions of the tire pressure maintainer device 100 are important design parameters for user convenience, the tire pressure maintainer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tire pressure maintainer device that provides a user with a modified tire rim which acts as a high-pressure reservoir, the tire pressure maintainer device comprising:
a tire rim;
an inlet; and
a regulator;
wherein the tire rim comprises a plurality of hollowed-out sections;
wherein the inlet allows access to the plurality of hollowed-out sections;
wherein the regulator is positioned between the tire rim and an inside of a tire; and
further wherein as the tire loses pressure over time, the regulator slowly releases air from the tire rim to the inside of the tire to maintain a tire's optimal pressure.

2. The tire pressure maintainer device of claim 1, wherein the tire pressure maintainer device is built directly into the tire rim of the tire.

3. The tire pressure maintainer device of claim 2, wherein any suitable vehicle tire can be utilized with the tire pressure maintainer device.

4. The tire pressure maintainer device of claim 3, wherein the tire pressure maintainer device is applied to each vehicle tire of a vehicle to maintain manufacturer-specified pressure of a vehicle's tires.

5. The tire pressure maintainer device of claim 4, wherein the plurality of hollowed-out sections are interconnected to form one large reservoir for retaining air for the vehicle tire.

6. The tire pressure maintainer device of claim 5, wherein the regulator connects the plurality of hollowed-out sections of the tire rim to the inside of the tire.

7. The tire pressure maintainer device of claim 6, wherein the regulator comprises a tensioned spring that is tensioned based on a pressure of an interior of the tire, such that the regulator automatically opens when the pressure within the tire drops to a certain level releasing air into the tire from the plurality of hollowed-out reservoirs.

8. The tire pressure maintainer device of claim 7, wherein the inlet allows air to be inserted into the plurality of hollowed-out sections.

9. The tire pressure maintainer device of claim 8, wherein the inlet is a one-way valve that only allows air to enter the hollowed-out sections and not to come back out through the inlet.

10. The tire pressure maintainer device of claim 9, wherein the inlet is positioned on the tire rim.

11. The tire pressure maintainer device of claim 10, wherein the tire rim is pressurized much higher than an optimal pressure required for the tire.

12. The tire pressure maintainer device of claim 11 further comprising a wireless communication module and additional sensors which would allow the tire pressure maintainer device to pair with a mobile application on a smart device, to control the tire pressure maintainer device, send notifications of low-pressure warnings, and display a tire pressure of each tire.

13. A tire pressure maintainer device that provides a user with a modified tire rim which acts as a high-pressure reservoir, the tire pressure maintainer device comprising:
a tire rim with an inlet; and
a regulator;
wherein the tire rim comprises a plurality of hollowed-out sections which are interconnected to form one large reservoir for retaining air for a vehicle tire;
wherein the inlet is a one-way valve positioned on the tire rim, that allows air to be inserted into the plurality of hollowed-out sections;
wherein the regulator is positioned between the tire rim and an inside of a tire and connects the plurality of hollowed-out sections of the tire rim to the inside of the tire;
wherein the regulator comprises a tensioned spring that is tensioned based on a pressure of an interior of the tire, such that the regulator automatically opens when the pressure within the tire drops to a certain level releasing air into the tire from the plurality of hollowed-out reservoirs;
wherein as the tire loses pressure over time, the regulator slowly releases air from the tire rim to the inside of the tire to maintain a tire's optimal pressure; and
further wherein the tire pressure maintainer device can be paired with a smart device for notifications and alerts.

14. The tire pressure maintainer device of claim 13 further comprising a second valve which allows the regulator to fully vent the hollowed-out sections during a blow out, to allow a driver (i.e., user 112) to keep control of the vehicle.

15. The tire pressure maintainer device of claim 13, wherein the tire pressure maintainer device is incorporated into the vehicle at a point of manufacture.

16. The tire pressure maintainer device of claim 13, wherein the tire pressure maintainer device is retrofitted on a standard vehicle tire rim by attaching a pressure vessel that secures to the standard vehicle tire rim.

17. The tire pressure maintainer device of claim 13 further comprising a wireless communication module and additional sensors which would allow the tire pressure maintainer device to pair with a mobile application on the smart device, to control the tire pressure maintainer device, send notifications of low-pressure warnings, and display a tire pressure of each tire in real time.

18. The tire pressure maintainer device of claim 13, wherein the smart device can be paired directly with a vehicle bus to send a user notifications and alerts.

19. The tire pressure maintainer device of claim 13 further comprising a plurality of indicia.

20. A method of maintaining tire pressure within a vehicle tire, the method comprising the following steps:
providing a tire pressure maintainer device comprising a modified tire rim with hollowed out sections, an inlet, and a regulator;
utilizing the inlet to highly pressurize the tire rim;
as the tire loses pressure over time, utilizing the regulator between the rim and the tire to slowly release pressure to ensure that the tire maintains optimal pressure;
sending notifications through a Bluetooth paired smartphone app; and
viewing the PSI of each tire on the paired smartphone application.
